(19) United States
(12) Patent Application Publication
(10) Pub. No.: US 2026/0219942 A1
(43) Pub. Date: Jul. 30, 2026

(54) TRANSPOSED TILE INSTRUCTIONS FOR MATRIX ACCELERATOR UNIT

(71) Applicant: ADVANCED MICRO DEVICES, INC., Santa Clara, CA (US)

(72) Inventors: Stuart David Simpson Biles, Bury St. Edmunds (GB); Glendon Leo Akins III, Fort Collins, CO (US); Michael Estlick, Fort Collins, CO (US)

(21) Appl. No.: 19/434,748

(22) Filed: Dec. 29, 2025

Related U.S. Application Data
(60) Provisional application No. 63/751,560, filed on Jan. 30, 2025.

(51) Int. Cl. G06F 9/50; G06F 7/78

(52) U.S. Cl. CPC G06F 9/5027; G06F 7/78

(57) ABSTRACT

An accelerator unit (AU) includes tile registers configured to store matrices associated with a machine-learning model to be implemented. Further, the AU supports a tile read column instruction that reads a column of elements from a matrix stored in the tile registers. When executing a tile read column instruction for a matrix, the AU first determines whether a transposed clone of the matrix is stored in the tile registers. If there is no transposed clone stored the AU generates a transposed clone by performing row read and tile write commands using the matrix. After confirming a transposed clone of the matrix is in the tile registers, the AU reads the rows of the transposed clone corresponding to the column indicated in the tile read column instruction.

### BACKGROUND

Some processing systems are configured to implement a machine-learning model for an application by performing matrix multiplication operations using matrices representing the parameters of the machine-learning model. For example, some processing systems include processing units, such as graphics processing units (GPUs), that have processor cores configured to perform matrix multiplication operations using various operands loaded into the vector registers of the processing units. Before performing these matrix multiplication operations, the processing units are configured to first retrieve data representing the matrices to be multiplied from the system memory. The processing units then load portions of these matrices into the vector registers of the processing units, and the processor cores of the processing units perform matrix multiplication operations using the loaded portions of the matrices as operands. After a processor core performs a matrix multiplication operation, the processor core stores the result of the matrix multiplication operation in the register vectors, the system memory, or both for additional tensor operations or to generate an output for the implemented machine-learning model.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to execute tile read column instructions using a matrix accelerator unit, in accordance with some embodiments.

FIG. 2 is a block diagram of an example process for executing a tile read column instruction using a matrix accelerator unit, in accordance with some embodiments.

FIG. 3 is an example architecture of an example tile register configured for direct tile row reads, in accordance with some embodiments.

FIG. 4 is an example architecture of an example tile register configured for direct tile row reads and direct tile column reads, in accordance with some embodiments.

FIG. 5 is an example process for generating a transposed clone of a tile by interleaving tile row read operations and tile column write operations, in accordance with embodiments.

FIG. 6 is an example method for executing a tile read column instruction using a matrix accelerator unit, in accordance with some embodiments.

### DETAILED DESCRIPTION

Systems and techniques disclosed herein include a processing system configured to execute one or more applications that implement one or more machine-learning models. Such machine-learning models include, for example, generative models (e.g., large language models (LLMs), multimedia large language models (MLLMs), generative adversarial networks (GANs), variational autoencoders (VAEs), diffusion models, transformer-based models, autoregressive models), neural networks (e.g., recurrent neural networks (RNNs), feedforward neural networks (FNNs), convolutional neural networks (CNNs), reinforcement models, supervised models, unsupervised models, distributed learning models, or any combination thereof, to name a few. When implementing a machine-learning model, the processing system is configured to perform tensor operations, such as scaled dot product operations, using matrices representing the parameters (e.g., weights) of the machine-learning model. To perform these tensor operations, the processing system includes one or more accelerator units (AUs) having one or more compute units that include circuitry (e.g., sets of same instruction, multiple data (SIMD) units, arithmetic logic units (ALUs), vector registers, scalar registers) configured to concurrently perform the same operation on different operands (e.g., different data). To help reduce the time needed for the AUs to perform these tensor operations, one or more of the AUs include one or more matrix accelerator units configured to provide specialized functional resources for operand delivery, accumulation, and execution. That is to say, a matrix accelerator unit is configured to more quickly provide the operands to the compute units when the compute units are performing the tensor operations. To this end, a matrix accelerator unit of an AU includes tile registers configured to store the values of a matrix (e.g., a tile) to be used as operands by the compute units. Additionally, the matrix accelerator unit includes interfaces and logic (e.g., tile register renamer logic, microprocessors, programmable logic devices, microcontrollers, memory controllers) configured to facilitate the transfer of data (e.g., operands) between the tile registers and the vector registers of the AU.

Further, the processing system includes a processing unit (e.g., central processing unit (CPU)) configured to issue instructions to the AU that, when executed by the AU, cause a matrix accelerator unit (e.g., logic of the matrix accelerator unit) of the AU to read data from one or more vector registers of AU, read data from one or more tile registers, read data from a system memory, write data to one or more vector registers of the AU, write data to one or more tile registers, write data to the system memory, or any combination thereof. For example, the processing unit is configured to issue instructions from an instruction set supported by the matrix accelerator unit. That is to say, the matrix accelerator unit has an instruction set architecture (ISA) configured to support a certain set of instructions that are issued by the processing unit. This instruction set supported by the matrix accelerator unit includes at least a tile read row instruction, a tile write row instruction, and a tile write column instruction. A tile read row instruction, when executed by the matrix accelerator unit, causes the matrix accelerator unit to read the values stored in a row of a tile register indicated by the instruction; a tile write row instruction, when executed by the matrix accelerator unit, causes the matrix accelerator unit to write values to a row of a tile register indicated by the instruction; and a tile write column instruction, when executed by the matrix accelerator unit, causes the matrix accelerator unit to write values to a column of a tile register indicated by the instruction. By supporting these tile read row instructions, tile write row instructions, and tile write column instructions, the matrix accelerator unit is enabled to move data between the tile registers and the vector registers of the AU, and between the tile registers and the system memory.

However, certain tensor operations to be performed for a machine-learning model require that a matrix first be transposed before values of the matrix may be used as operands. As such, systems and techniques disclosed herein are directed toward a matrix accelerator unit configured to support a tile read column instruction that allows values of a transposed tile (e.g., matrix) to be used as operands. That is to say, the matrix accelerator unit has an ISA supporting an instruction set that includes a tile read column instruction. A tile read column instruction, for example, indicates the tile register storing the tile from which data (e.g., values) is to be read (e.g., indicates the logical name of the tile register) and the column of the tile from which data is to be read. When this tile read column instruction is executed by the matrix accelerator unit, the matrix accelerator unit first checks whether there is a valid transposed clone associated with the tile register indicated by the tile read column instruction (e.g., a valid transposed copy of the tile stored in the indicated tile register). For example, the matrix accelerator unit checks tile metadata associated with the tile registers (e.g., flags) that indicate whether there are corresponding valid transposed clones associated with the tiles in the tile registers. In response to there being a valid transposed clone associated with the tile register, the matrix accelerator unit determines the tile register storing the transposed clone (e.g., from the metadata associated with the tile register indicated by the instruction) and performs a tile read operation to read values from the row of the transposed clone corresponding to the column of the tile in the tile register indicated by the instruction.

In response to there not being a valid transposed clone associated with the tile register indicated by the instruction, the matrix accelerator unit is configured to generate a transposed clone for the indicated tile register by first allocating a tile register (e.g., physical tile register) to store the transposed clone. After allocating the tile register, the matrix accelerator unit performs a predetermined number of tile row read operations (e.g., a number of tile read row operations corresponding to the number of rows in the tile of the tile register indicated by the instruction) to read the values of all the rows of the tile in the indicated tile register and performs a predetermined number of tile column write operations (e.g., a number of tile write column operations corresponding to the number of rows in the tile of the tile register indicated by the instruction) that write the read values into corresponding columns of a tile in the newly allocated tile register to produce a transposed clone stored in the newly allocated tile register. After producing the transposed clone, the matrix accelerator unit then reads values from the row of the transposed clone corresponding to the column of the tile indicated by the tile read column instruction. In this way, the matrix accelerator unit is configured to support the reading of tile columns stored in the tile registers without the need for additional wiring or circuitry in the matrix accelerator unit. Further, the matrix accelerator unit is enabled to provide values of a transposed matrix to the vector registers as operands, increasing the number of tensor operations the AU may perform for a machine-learning model.

Additionally, to help reduce the time and processing resources needed to generate a transposed clone of a tile, a matrix accelerator unit is configured to interleave the tile row read operations and tile column write operations used to generate the transposed clone. For example, the matrix accelerator unit performs a first tile row read operation to read the values of a first row of a tile to be transposed and stores these values in a buffer (e.g., an output buffer). The matrix accelerator unit then performs a first tile column write operation to write the values in the buffer to a first column of the transposed clone (e.g., the tile register allocated to store the transposed clone). Next, the matrix accelerator unit performs a second tile row read operation to read the values of a row of the tile to be transposed, stores these values in the buffer, and performs a second tile column write operation to write the values in the buffer to a second column of the transposed clone. The matrix accelerator unit then continues in this way until each row of the tile to be transposed has been read and each column of the transposed clone has been written. By interleaving the tile row read operations and tile column write operations in this way, the matrix accelerator unit is not required to write the values read from the rows of the tile to be transposed in the vector registers or system memory, reducing the number of memory accesses, time, and processing resources needed to generate a transposed clone.

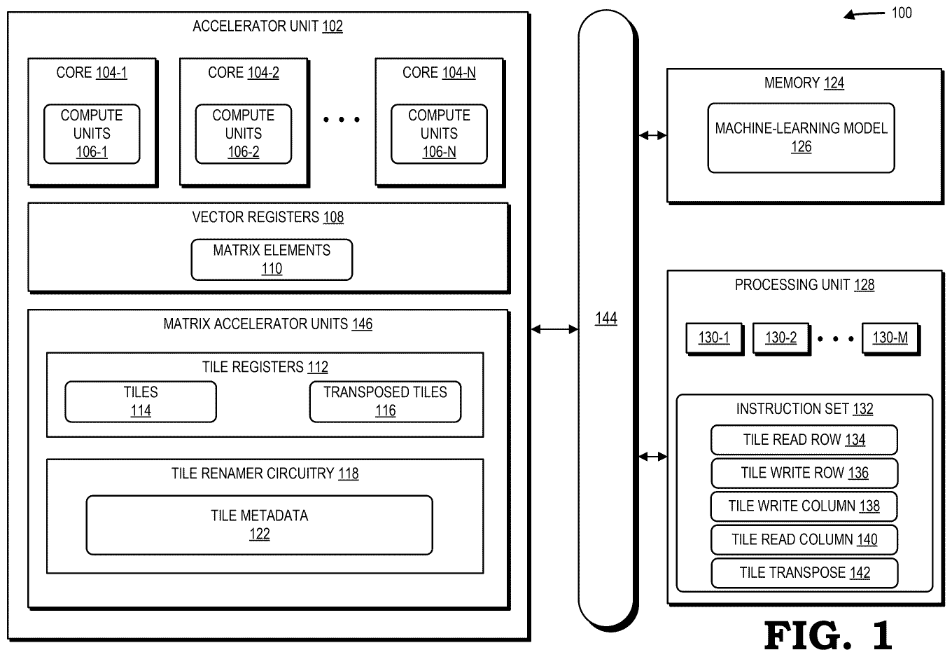

Referring now to FIG. 1, a processing system 100 configured to execute tile column read operations using a matrix accelerator unit is presented, in accordance with embodiments. In embodiments, processing system 100 is configured to execute one or more applications that require the implementation of one or more machine-learning models 126 that include, for example, one or more generative models (e.g., LLMs, MLLMs, GANs, VAEs, diffusion models, transformer-based models), autoregressive models, neural networks (e.g., RNNs, FNNs, CNNs), reinforcement models, supervised models, unsupervised models, distributed learning models, or any combination thereof—to name a few. To implement these machine-learning models 126, the processing system 100 includes a processing unit 128 (e.g., CPU) configured to issue instructions to an AU 102 that, when executed by the AU 102, cause the AU 102 to perform one or more tensor operations for a machine-learning model 126, such as matrix multiplication operations (e.g., scaled dot product operations), addition operations, subtraction operations, and the like. As an example, the processing unit 128 loads instructions to a ring buffer from which the AU 102 (e.g., a command processor of the AU 102) retrieves the instructions. The AU 102 then executes the instructions and performs tensor operations (e.g., matrix multiplication operations) using matrices representing parameters (e.g., weights) associated with a machine-learning model 126. To issue these instructions, processing unit 128 includes one or more processor cores 130 that are each configured to concurrently execute multiple (e.g., two) threads (e.g., sequences of instructions). Though the example embodiment presented in FIG. 1 shows the processing unit 128 as including three processor cores (130-1, 130-2, 130-M) representing an M integer number of processor cores, in other embodiments, processing unit 128 can include any non-zero integer number of processor cores 130.

The AU 102, in embodiments, is configured to operate as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof. To perform tensor operations (e.g., matrix multiplication operations) for a machine-learning model 126, the AU 102 includes a plurality of processor cores 104-1 to 104-N that execute instructions (e.g., from instruction set 132) concurrently or in parallel. In some implementations, one or more of the processor cores 104 operate as one or more compute units 106 that have circuitry (e.g., sets of SIMD units, ALUs, vector registers 108) configured to perform the same operation on different data sets. Though in the example implementation illustrated in FIG. 1, the AU 102 includes three processor cores (104-1, 104-2, 104-N) representing an N integer number of cores each operating as a corresponding set of compute units (106-1, 106-2, 106-N), the number of processor cores 104 implemented in AU 102 and the number of processor cores 104 operating as a set of one or more compute units 106 is a matter of design choice. As such, in other implementations, AU 102 can include any non-zero integer number of processor cores 104 operating as any non-zero integer number of compute units 106.

In embodiments, AU 102 is configured to execute one or more matrix multiplication operations for a machine-learning model 126 by loading data representing at least portions of corresponding matrices representing the weights of the machine-learning model 126 (represented in FIG. 1 as matrix elements 110) into vector registers 108 included in or otherwise connected to the compute units 106 (e.g., processor cores 104 operating as compute units 106) that will be executing the matrix multiplication operations. A matrix element 110, for example, includes data representing one or more values from one or more rows, one or more columns, or both of a corresponding matrix representing the weights of a machine-learning model 126. According to embodiments, AU 102 is configured to retrieve these matrix elements 110 from one or more caches (not shown for clarity) included in or otherwise connected to processor cores 104 or processor cores 130, memory 124 (e.g., a system memory), or both. After loading the matrix elements 110 into corresponding vector registers 108, one or more compute units 106 execute the matrix multiplication operation using the matrix elements 110 in the vector registers 108 to generate one or more results. For example, the compute units 106 execute the matrix multiplication operations using the matrix elements 110 in the vector registers 108 to generate a result representing at least a portion of a new matrix. The compute units 106 then store this result in one or more vector registers 108 (e.g., for use in additional tensor operations), a cache, memory 124, or any combination thereof.

To reduce the time needed to perform these matrix multiplication operations, the AU 102 includes one or more matrix accelerator units 146 configured to reduce the number of memory accesses between the vector registers 108 and a cache, the vector registers 108 and the memory 124 (e.g., system memory), or both, which, in turn, reduces the time and processing resources needed to perform the matrix multiplication operations. A matrix accelerator unit 146, for example, includes tile registers 112 configured to store tiles 114 that represent the matrices associated with a machine-learning model 126 (e.g., represent the matrices including the weights of a machine-learning model 126). As an example, a first tile register stores a first tile representing a first matrix of weights of a machine-learning model 126, and a second tile register stores a second tile representing a second matrix of weights of a machine-learning model 126. According to embodiments, a matrix accelerator unit 146 includes logic configured to retrieve data representing tiles 114 from memory 124. For example, in response to receiving one or more instructions from the processing unit 128 indicating a tile 114 (e.g., matrix) to be loaded and the tile register 112 (e.g., logical tile register address) into which the tile 114 is to be loaded, the tile renamer circuitry 118 of the matrix accelerator unit 146 (e.g., one or more microprocessors, renamers, buffers) allocates a tile register 112 to store the indicated tile 114 by associating a physical tile register address (e.g., the physical address of a tile register 112) to the logical tile register address indicated in the instruction. The matrix accelerator unit 146 then loads the tile 114 from memory 124 into the allocated tile register 112. In embodiments, tile renamer circuitry 118 maintains a set of data (e.g., tile metadata 122) indicating which logical tile register addresses are associated with physical tile register addresses, which tile registers 112 are associated with a corresponding valid transposed clone, which tile registers 112 store a valid transposed clone, and the like. For example, after allocating a tile register 112 and storing a tile 114 in the allocated tile register 112, tile renamer circuitry 118 is configured to update tile metadata 122 to indicate which logical tile addresses are associated with the physical tile address of the allocated tile register 112, the tile 114 stored in the tile register 112, or both.

Further, the matrix accelerator unit 146 is configured to transfer operands (e.g., the matrix elements 110 to be used in tensor operations performed by corresponding compute units 106) between tile registers 112 and the vector registers 108 included in or otherwise connected to the compute units 106 of the AU 102. As an example, the matrix accelerator unit 146 loads matrix elements 110 from one or more tiles 114 stored in one or more tile registers 112 into corresponding vector registers 108, which the compute units 106 then use to perform one or more tensor operations for a machine-learning model 126. Further, after one or more compute units 106 execute one or more tensor operations to generate one or more results, a matrix accelerator unit 146 is configured to load these results from the vector registers 108 into corresponding tile registers 112 so as to update the tiles 114 (e.g., matrices) stored in these tile registers 112. By transferring data between the tile registers 112 and the vector registers 108, the matrix accelerator unit 146 reduces the number of memory accesses between the vector registers 108 and a cache, the vector registers 108 and the memory 124, or both, which reduces the time and processing resources needed to load operands for and perform tensor operations for a machine-learning model 126.

To facilitate the transfer of data between a matrix accelerator unit 146 and the vector registers 108, the matrix accelerator unit 146 supports an instruction set 132 including instructions that, when executed by the matrix accelerator unit 146, cause the matrix accelerator unit to read data from and write data to particular tile registers 112. That is to say, the matrix accelerator unit 146 includes an ISA configured to execute instructions from instruction set 132 that transfer data between the tile registers 112 and vector registers 108. Instruction set 132 includes, for example, at least a tile read row instruction 134, a tile write row instruction 136, and a tile write column instruction 138. A tile read row instruction 134 indicates the tile register 112 (e.g., a logical tile register address) and the corresponding row of a tile 114 from which data is to be read. When the tile read row instruction 134 is executed by a matrix accelerator unit 146, the matrix accelerator unit 146 reads the values from the row indicated by the instruction from a tile 114 stored at the address indicated by the instruction and stores the read values (e.g., read matrix elements 110) in a buffer (e.g., output buffer). From this buffer, the read values are then provided, for example, to vector registers 108. Additionally, a tile write row instruction 136 indicates the tile register 112 (e.g., a logical tile register address) and the corresponding row of a tile 114 into which data is to be written. When executed by the matrix accelerator unit 146, the tile write row instruction 136 causes the matrix accelerator unit 146 to write the values from an input buffer into a corresponding row indicated by the instruction of a tile 114 stored at the tile register address indicated by the instruction. Further, a tile write column instruction 138 indicates the tile register 112 (e.g., a logical tile register address) and the corresponding row of a tile 114 into which data (e.g., matrix elements 110) is to be written. When the tile write column instruction 136 is executed by a matrix accelerator unit 146, the matrix accelerator unit 146 writes the values from the input buffer into a corresponding column indicated by the instruction of a tile 114 stored at the tile register address indicated by the instruction.

However, certain tensor operations to be performed by the compute units 106 require that a tile 114 (e.g., a matrix) be first transposed before values from the tile 114 may be used as operands. To this end, the instruction set 132 supported by the matrix accelerator units 146 also includes a tile read column instruction 140 and a tile transpose instruction 142. This tile transpose instruction 142, for example, indicates the tile register 112 (e.g., logical address of the tile register) storing a tile 114 to be transposed. When executing a tile transpose instruction 142, a matrix accelerator unit 146 first allocates a tile register 112 to store a transposed clone (represented in FIG. 1 as transposed tiles 116) of the tile 114 stored at the tile register 112 indicated by the instruction. For example, the tile renamer circuitry 118 allocates a physical tile register address at which the transposed tile 116 is to be stored. After the tile register 112 for the transposed tile 116 is allocated, the matrix accelerator unit 146 performs a predetermined number of tile row read operations that read the values from each row of the tile 114 to be transposed. As an example, the matrix accelerator unit 146 performs a number of tile row read operations that ensure values from each row of the tile 114 to be transposed are read. Additionally, the matrix accelerator unit 146 performs a predetermined number of tile column write operations that write values from each read row of the tile 114 to be transposed into corresponding columns of the transposed tile 116 at the allocated tile register 112. For example, the matrix accelerator unit 146 performs a number of tile column write operations that ensure values read from each row of the tile 114 to be transposed are written to the corresponding columns of the transposed tile 116. After performing the predetermined number of tile row read operations and tile column write operations, the matrix accelerator unit 146 updates tile metadata 122 associated with the tile 114 at the tile register 112 indicated by the instruction (e.g., the tile that was transposed) to indicate that a valid transposed clone of the tile 114 is present and is stored at a corresponding tile register 112 (e.g., the newly allocated tile register 112).

Further, a tile read column instruction 140 allows a matrix accelerator unit 146 to read the columns of a tile 114 (e.g., the rows of a transposed tile 116) without requiring the matrix accelerator unit 146 to have dedicated circuitry that allows for the direct reading of tile columns. For example, the tile read column instruction 140 indicates the tile register 112 (e.g., the logical address of the tile register 112) and the column of a tile 114 from which data is to be read. When this instruction is executed by the matrix accelerator unit 146, the matrix accelerator unit 146 first checks to determine whether there is a valid transposed clone of the tile 114 (e.g., an associated transposed tile 116) indicated by the tile read column instruction 140. As an example, the matrix accelerator unit 146 checks the tile metadata 122 associated with the tile 114 at the tile register 112 indicated by the tile read column instruction 140 to determine whether a valid transposed clone of the tile 114 is present (e.g., is stored in the tile registers 112). As another example, the matrix accelerator unit 146 checks one or more flags associated with the tile 114 at the tile register 112 indicated by the tile read column instruction 140 to determine whether a valid transposed clone of the tile 114 is present. As an additional example, the matrix accelerator unit 146 checks one or more encoded tile register addresses to determine whether a tile register 112 stores a valid transposed clone for a requested tile 114. In response to there being a valid transposed clone for the indicated tile 114, the matrix accelerator unit 146 performs a tile row read operation on the transposed tile (e.g., on the transposed clone stored at a tile register 112) such that the matrix accelerator unit 146 reads the values from the row of the transposed tile 116 corresponding to the column of the tile 114 indicated by the tile read column instruction 140 and stores the read values, for example, in an output buffer.

Additionally, during execution of a tile read column instruction 140, in response to there being no valid transposed clone for the indicated tile 114, the matrix accelerator unit 146 generates a transposed tile 116 for the indicated tile 114, similarly to a tile transpose instruction 142. As an example, the matrix accelerator unit 146 first allocates a tile register 112 to store the transposed tile 116. After allocating this tile register 112 for the transposed tile 116, the matrix accelerator unit 146 performs a predetermined number of tile row read operations that read the values from each row of the tile 114 to be transposed. Further, the matrix accelerator unit 146 performs a predetermined number of tile column write operations that write values from each read row of the tile 114 to be transposed into corresponding columns of the transposed tile 116 at the allocated tile register 112. After performing the predetermined number of tile row read operations and tile column write operations, the matrix accelerator unit 146 updates tile metadata 122 associated with the tile 114 at the tile register 112 indicated by the instruction (e.g., the tile that was transposed) to indicate that a valid transposed clone of the tile 114 is present. The matrix accelerator unit 146 then performs a tile row read operation on the transposed tile 116 such that the matrix accelerator unit 146 reads the values from the row of the transposed tile 116 corresponding to the column of the tile 114 indicated by the tile read column instruction 140 and stores the read values, for example, in an output buffer. In this way, the tile read column instruction 140 supported by the matrix accelerator unit 146 enables the matrix accelerator unit 146 to read columns of tiles 114 stored in the tile registers 112 without needing additional circuitry that allows for direct reading of tile columns. Further, due to the matrix accelerator unit 146 being enabled to read the columns of tiles 114, the matrix accelerator unit 146 is able to provide matrix elements 110 of transposed tiles (e.g., rows of transposed tiles corresponding to the columns of the tiles) to the compute units 106 for use as operands in tensor operations.

According to some embodiments, when generating a transposed tile 116 during execution of a tile read column instruction 140 or tile transpose instruction 142, the matrix accelerator unit 146 is configured to store values read from the rows of a tile 114 in vector registers 108, memory 124, or both before writing the values to the columns of the transposed tile 116. That is to say, the matrix accelerator unit 146, when performing the predetermined number of tile row read operations, is configured to store the values read from the rows of a tile 114 in vector registers 108, memory 124, or both. Further, when performing the predetermined number of tile column write operations, the matrix accelerator unit 146 writes the values in the vector registers 108, memory 124, or both to the columns of the transposed tile 116 in the tile registers 112. To help reduce the number of memory accesses when generating a transposed tile 116, the matrix accelerator unit 146 is configured to interleave the tile row read operations and tile column write operations performed when generating the transposed tile 116. For example, the matrix accelerator unit 146 performs a first tile row read operation to read the values from a first row of a tile 114 to be transposed and stores these read values in a buffer (e.g., output buffer). The matrix accelerator unit 146 then performs a first tile column write operation to write the values in the buffer to a corresponding first column of the transposed tile 116 (e.g., at a newly allocated tile register 112). Next, the matrix accelerator unit 146 performs a second tile row read operation to read the values from a second row of a tile 114 to be transposed, stores these read values in the buffer, and performs a second tile column write operation to write the values in the buffer to a corresponding second column of the transposed tile 116. The matrix accelerator unit 146 then continues in this way until the values of each row of the tile 114 to be transposed have been read and the read values have been written to the corresponding columns of the transposed tile 116. By interleaving the tile row read operations and tile column write operations in this way, the matrix accelerator unit 146 does not need to store values read from the rows of a tile 114 to be transposed in vector registers 108, memory 124, or both, reducing the number of memory accesses to the vector registers 108, memory 124, or both and reducing the amount of time and processing resources needed to generate the transposed tile 116.

In embodiments, AU 102, processing unit 128, or both has access to memory 124 or other storage component implemented using a non-transitory computer-readable medium, for example, a dynamic random-access memory (DRAM). In some embodiments, memory 124 is implemented using other types of memory, including, for example, static random-access memory (SRAM), nonvolatile RAM, a cache (e.g., L0 cache, L1 cache, L2 cache, last-level cache), and the like. Further, in embodiments, processing system 100 includes connection circuitry 144 (e.g., data fabrics, buffers, memory controllers) configured to communicatively couple the components of processing system 100 to one another. For example, connection circuitry 144 is configured to communicatively couple AU 102 to memory 124, AU 102 to processing unit 128, processing unit 128 to memory 124, or any combination thereof.

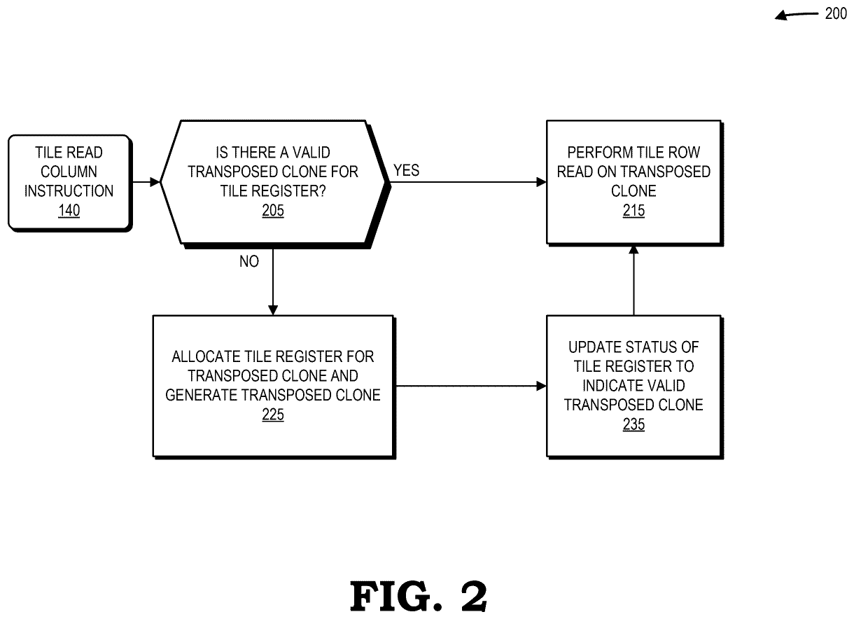

Referring now to FIG. 2, an example process 200 for executing a tile column read instruction using a matrix accelerator unit is presented, in accordance with embodiments. In embodiments, example process 200 is implemented by a matrix accelerator unit 146 when executing a tile read column instruction 140. Example process 200 includes, at block 205, the matrix accelerator unit 146 receiving a tile read column instruction 140 indicating a tile register 112 (e.g., logical address of a tile register) and a specific column of a tile 114 from which values (e.g., matrix elements 110, operands) are to be read. In response to receiving this tile read column instruction 140, the matrix accelerator unit 146 determines whether there is a valid transposed clone (e.g., a transposed tile 116) corresponding to the tile 114 at the tile register 112 indicated by the instruction (e.g., at the tile register address indicated by the instruction). To determine whether there is a transposed tile 116 for the tile 114 indicated by the tile read column instruction 140, for example, the matrix accelerator unit 146 checks the tile metadata 122 associated with the tile register 112 indicated by the tile read column instruction 140 to determine whether the tile metadata 122 indicates there is a transposed tile 116 for the tile register 112 (e.g., for the tile 114 stored in the tile register 112). As another example, the matrix accelerator unit 146 checks one or more flags associated with the tile register 112 indicated by the tile read column instruction 140 to determine whether there is a transposed tile 116 for the tile register 112 (e.g., for the tile 114 stored in the tile register 112). As an additional example, the matrix accelerator unit 146 checks one or more encoded tile register addresses to determine whether a tile register 112 stores a transposed tile 116 for a requested tile 114 (e.g., for the tile 114 stored in the indicated tile register 112).

In response to there being a transposed tile 116 for the tile 114 indicated by the tile read column instruction 140, at block 215, the matrix accelerator unit 146 reads values from the row of the transposed tile 116 that corresponds to the column of the tile 114 to be transposed indicated by the tile read column instruction 140. The matrix accelerator unit 146 then stores these read values in a buffer. According to some embodiments, the matrix accelerator unit 146 is configured to determine the tile register 112 at which a transposed tile 116 is stored based on tile metadata 122, tile register addresses (e.g., encoded tile register addresses), or both. Referring again to block 205, in response to there not being a transposed tile 116 for the tile indicated by the tile read column instruction 140, the matrix accelerator unit 146, at block 225, is configured to generate a transposed tile 116 for the indicated tile 114. For example, the matrix accelerator unit 146 (e.g., tile renamer circuitry 118) first allocates a tile register 112 to store the transposed tile 116 for the indicated tile 114. In embodiments, the matrix accelerator unit 146 allocates a tile register 112 to store the transposed tile 116 by updating tile metadata 122 to indicate that a physical tile register address stores the transposed tile 116 for the indicated tile 114 (e.g., the tile register 112 storing the indicated tile 114).

Still referring to block 225, after allocating a tile register 112 to store the transposed tile 116, the matrix accelerator unit 146 performs a predetermined number of tile row read operations that read the values from each row of the tile 114 indicated by the tile read column instruction 140. Further, the matrix accelerator unit 146 performs a predetermined number of tile column write operations that write the values read from the rows of the indicated tile 114 into corresponding columns of the transposed tile 116 stored at the newly allocated tile register. In some embodiments, matrix accelerator unit 146 interleaves these tile row read operations and tile column write operations such that values are not first written to vector registers 108, memory 124, or both before being written to the transposed tile 116 at the newly allocated tile register. After writing the read values and generating the transposed tile 116 stored at the newly allocated tile register, at block 235, the matrix accelerator unit 146 updates the tile metadata 122 to indicate that the tile register 112, tile 114, or both has a valid transposed clone stored at the newly allocated tile register. The matrix accelerator unit 146 then, at block 215, reads values from the row of the transposed tile 116 that correspond to the column of the tile 114 indicated by the tile read column instruction 140, and stores these read values in a buffer.

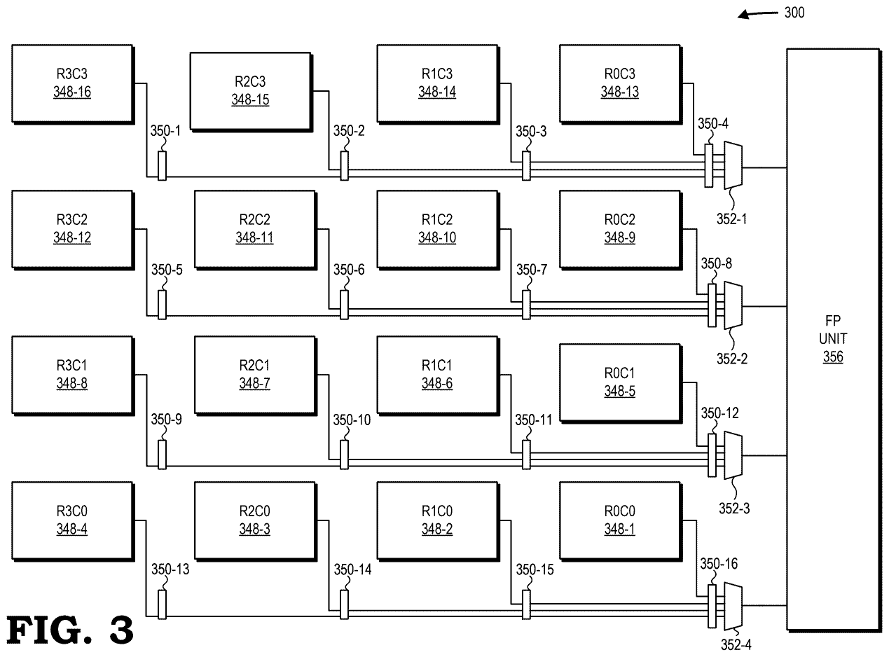

Referring not to FIG. 3, an example architecture 300 of an example tile register configured for direct tile row reads is presented, in accordance with embodiments. In embodiments, example architecture 300 is implemented in a matrix accelerator unit 146 supporting instruction set 132. Example architecture 300 includes data blocks 348 storing at least one value of a tile 114 corresponding to certain positions in a certain row and certain column of the tile 114. For example, a first data block 348-1 includes a value having a first position within a first row (e.g., R0) of a tile 114 and a first position within a first column (e.g., C0) of the tile 114; a fifth data block 348-5 includes a value having a second position within the first row of the tile 114 and a first position within a second column (e.g., C1) of the tile 114; a ninth data block 348-9 includes a value having a third position within the first row of the tile 114 and a first position within a third column (e.g., C2) of the tile 114; and a thirteenth data block 348-13 includes a value having a fourth position within the first row of the tile 114 and a first position within a fourth column (e.g., C3) of the tile 114. As another example, the first data block 348-1 includes a value having a first position within the first row of a tile 114 and a first position within the first column of the tile 114; a second data block 348-2 includes a value having a first position within a second row (e.g., R1) of the tile 114 and a second position within the first column of the tile 114; a third data block 348-3 includes a value having a first position within a third row (e.g., R2) of the tile 114 and a third position within the first column of the tile 114; and a fourth data block 348-4 includes a value having a first position within a fourth row (e.g., R3) of the tile 114 and a fourth position within the first column of the tile 114. Though the example embodiment presented in FIG. 3 shows example architecture 300 as including sixteen data blocks (348-1, 348-2, 348-3, 348-4, 348-5, 348-6, 348-7, 348-8, 348-9, 348-10, 348-11, 348-12, 348-13, 348-14, 348-15, 348-16) representing values at corresponding locations of a tile 114, in other embodiments, example architecture 300 can include any non-zero integer number of data blocks 348 representing values at corresponding locations of a tile 114.

When executing a tile read row instruction 134, a matrix accelerator unit 146 including example architecture 300 is configured to directly provide the values of data blocks 348 representing the row of a tile 114 to a floating point unit 356 including circuitry configured to, for example, combine the values of the data blocks 348 into a vector, scale the values, store the values in a buffer, or any combination thereof. As an example, within example architecture 300, the data blocks 348 representing values of the same column of a tile 114 are each connected to a corresponding multiplexer 352. When a tile read row instruction 134 is executed, each multiplexer 352 is configured to select the value of a column corresponding to the row indicated by the tile read row instruction 134 and provide this selected value to the floating point unit 356, which then, for example, scales the values, generates a vector representing the values, or both. As an example, for a tile read row instruction 134 indicating that a second row (e.g., R1) of a tile 114 is to be read, a first multiplexer 352-1 selects the value in data block 348-14 and provides this value to the floating point unit 356; a second multiplexer 352-2 selects the value in data block 348-10 and provides this value to the floating point unit 356; a third multiplexer 352-3 selects the value in data block 348-6 and provides this value to the floating point unit 356; and a fourth multiplexer 352-4 selects the value in data block 348-2 and provides this value to the floating point unit 356. According to embodiments, by executing the tile read row instruction 134 in this way, a number of floating-point operations (FLOPs) (e.g., represented in FIG. 3 as FLOPs 350) based on the number of values in a row of a tile 114 is introduced. For example, for a tile read row instruction 134 indicating the second row of the tile 114, a first FLOP 350-3 from reading dating block 348-14 is introduced; a second FLOP 350-7 from reading dating block 348-10 is introduced; a third FLOP 350-11 from reading dating block 348-6 is introduced; and a fourth FLOP 350-15 from reading dating block 348-2 is introduced.

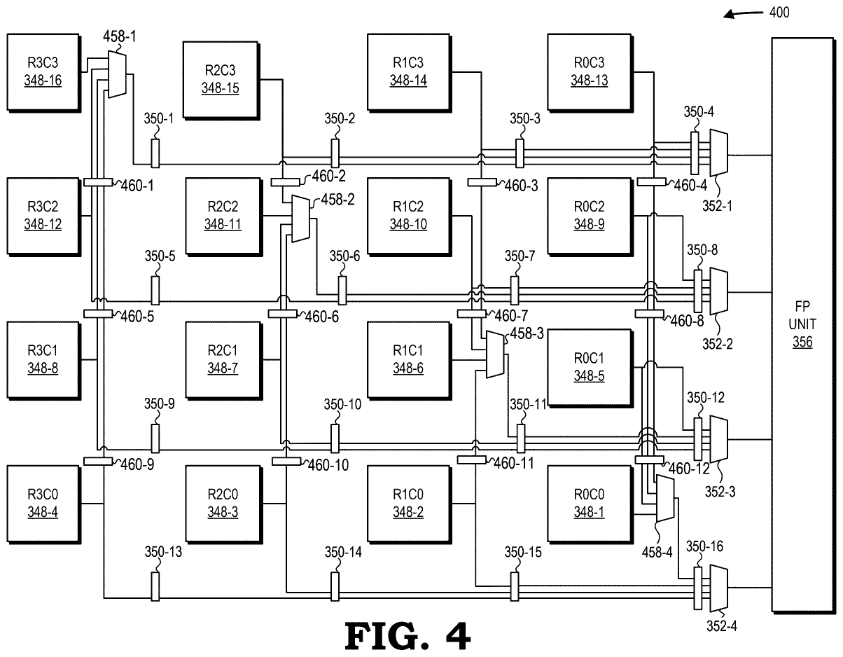

Referring now to FIG. 4, an example architecture 400 of an example tile register configured for direct tile column reads is presented, in accordance with embodiments. In embodiments, example architecture 400 is implemented in a matrix accelerator unit 146 supporting instruction set 132. Example architecture 400 includes data blocks 348 storing at least one value of a tile 114 corresponding to certain positions in a certain row and certain column of the tile 114, similar to, or the same as, example architecture 300. According to embodiments, example architecture 400 is configured to perform direct reads of values in columns of a tile 114 when executing a tile column read operation. For example, in addition to corresponding multiplexers 352 connected to each data block 348 storing a value in a certain column of the tile 114, the example architecture 400 includes corresponding multiplexers 458 connected to each data block 348 storing a value in a certain row of the tile 114. As an example, a first multiplexer 458-1 is connected to each data block (348-16, 348-12, 348-8, 248-4) storing a value in the fourth row of the tile 114 and a second multiplexer 458-2 is connected to each data block (348-15, 348-11, 348-7, 248-3) storing a value in the third row of the tile 114.

When performing a tile read column operation, a matrix accelerator unit 146 including example architecture 400 is configured to directly provide the values of data blocks 348 representing the column of a tile 114 to a floating point unit 356. For example, to perform a tile read column operation, each multiplexer 458 connected to values of a corresponding row of a tile 114 selects the value from the row corresponding to the column indicated by the tile read column operation. As an example, to read values from the third column of a tile 114, a first multiplexer 458-1 is configured to select the value from data block 348-12 representing a value in the fourth column of the tile 114 and provide the selected value to a multiplexer 352-1 connected to the data blocks 348 storing values in the third column of the tile 114; a second multiplexer 458-2 is configured to select the value from data block 348-11 representing a value in the third column of the tile 114 and provide the selected value to a multiplexer 352-2 connected to the data blocks 348 storing values in the third column of the tile 114; a third multiplexer 458-3 is configured to select the value from data block 348-10 representing a value in the third column of the tile 114 and provide the selected value to a multiplexer 352-3 connected to the data blocks 348 storing values in the second column of the tile 114; and a fourth multiplexer 458-4 is configured to select the value from data block 348-9 representing a value in the third column of the tile 114 and provide the selected value to a multiplexer 352-1 connected to the data blocks 348 storing values in the first column of the tile 114. Each multiplexer 352 then selects the value output from a corresponding multiplexer 458 and provides the values to the floating point unit 356, which scales the values, generates a vector representing the vectors (e.g., representing the third column of the tile 114), or both.

However, including multiplexers 458 to allow for the direct reading of columns introduces a greater number of FLOPs, compared to the example architecture 300 when performing tile row read operations. For example, when performing a tile column read operation for a column of a tile 114, a set of FLOPs 460 (e.g., three flops) is introduced for each multiplexer 458. As an example, for multiplexer 458-1, a first FLOP 460-1 is introduced by reading the value from data block 348-12, a second FLOP 460-5 is introduced by reading the value from data block 348-8, and a third FLOP is introduced by reading the value from data block 348-4. Further, a set of FLOPs 350 is introduced for each multiplexer 352 that provides a value of a column to the floating point unit 356. For example, for the multiplexer 350-4, a FLOP 350-1 is introduced by selecting the value for multiplexer 458-1, a FLOP 350-2 is introduced by reading the value from data block 348-15, a FLOP 350-3 is introduced by reading the value from data block 348-14, and a FLOP 350-4 is introduced by reading the value 348-13 from data block 348-13. As such, example architecture 400 performing a direct tile column read operation introduces a greater number of FLOPS (e.g., FLOPs 460 and FLOPs 350) than example architecture 300 performing a direct tile row read operation or executing a tile read row instruction 134.

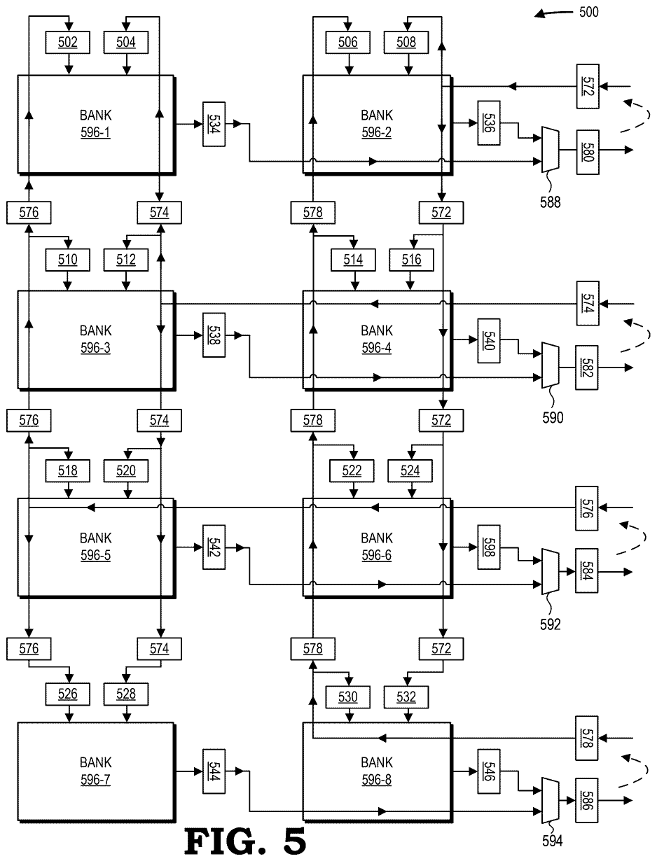

Referring now to FIG. 5, an example processing 500 for generating a transposed clone of a tile by interleaving tile row read operations and tile column write operations is presented, in accordance with embodiments. In embodiments, example process 500 is implemented by a matrix accelerator unit 148 generating a transposed tile 116 while executing a tile read column instruction 140, tile transpose instruction 142, or both. For example, example process 500 includes interleaving tile row read operations and tile column write operations while generating a transposed tile 116. Example process 500 includes, in some embodiments, a matrix accelerator unit 148 having tile registers 112 arranged into memory banks 596 (e.g., arranged according to example architecture 300), with each memory bank 596 including data blocks (e.g., a 4×4 arrangement of data blocks 348) each including values (e.g., rows of values) for a tile 114 to be transposed. In embodiments, example process 500 begins with the matrix accelerator unit 148 performing a first tile row read operation during which a first row of values 544 is read out of memory bank 596-7, a second row of values 546 is read out of memory bank 596-8, and both the first row of values 544 and second row of values 546 are provided to multiplexer 594. Multiplexer 594 is configured to select, from the first row of values 544 and the second row of values 546, the first row of values of the tile 114 to be transposed and to provide this first row of values of a tile 114 to be transposed as an output 586 to, for example, a floating point unit 356 (e.g., a buffer of the floating point unit 356, a bus of the floating point unit 356, or both). The matrix accelerator unit 146 then performs a first tile column write operation using the output 586. For example, using the output 586 as an input 578 from the floating point unit 356, the matrix accelerator unit 148 provides respective portions of the input 578 (e.g., output 586) representing the first row of the tile to be transposed 114 to an input 530 of memory bank 596-8, an input 522 of memory bank 596-6, an input 514 of memory bank 596-4, and an input 506 of memory bank 596-2, which are then used to update these memory banks 596-2, 596-4, 596-6, and 598-8. That is to say, using corresponding portions of input 576, the matrix accelerator unit 146 writes values to a first column of the transposed tile 116 stored between memory banks 596-2, 596-4, 596-6, and 596-8.

After performing the first tile column write operation, example process 500 includes the matrix accelerator unit 146 performing a second tile row read operation. During this second tile row read operation, the matrix accelerator unit 146 reads a third row of values 542 from memory bank 596-5, a fourth row of values 598 from memory bank 596-6, and provides both the third row of values 542 and the fourth row of values 598 to multiplexer 592. Multiplexer 592 is configured to select the row of values representing the second row of the tile 114 to be transposed from the third row of values 542 and the fourth row of values 598 and provide the selected row of values as an output 584 to the floating point unit 356. The matrix accelerator unit 146 then performs a second tile column write operation by using the output 584 as an input 576 to the second tile column write operation. For example, the matrix accelerator unit 146 provides respective portions of the input 576 (e.g., output 584) to input 502 of memory bank 596-1, input 510 of memory bank 596-3, input 518 of memory bank 596-5, and input 526 of memory bank 596-7 so that the matrix accelerator unit 146 writes values to a second column of the transposed tile 116 stored between memory banks 596-1, 596-3, 596-5, and 596-7. Additionally, the matrix accelerator unit 146 then performs a third tile row read operation, during which the matrix accelerator unit 146 reads a fifth row of values 538 from memory bank 596-3, a sixth row of values 540 from memory bank 596-4, and provides both the fifth row of values 538 and the sixth row of values 540 to multiplexer 590. Multiplexer 590 selects the row of values representing the third row of the tile 114 to be transposed from the fifth row of values 538 and the sixth row of values 540 and provides the selected row of values as an output 582 to the floating point unit 356. The matrix accelerator unit 146 next performs a third tile column write operation by using the output 582 as an input 574. As an example, the matrix accelerator unit 146 provides respective portions of the input 574 (e.g., output 582) to input 504 of memory bank 596-1, input 512 of memory bank 596-3, input 520 of memory bank 596-5, and input 528 of memory bank 596-7 so that the matrix accelerator unit 146 writes values to a third column of the transposed tile 116 stored between memory banks 596-1, 596-3, 596-5, and 596-7.

Further, during example process 500, the matrix accelerator unit 146 performs a fourth tile row read operation, during which a seventh row of values 534 is read out of memory bank 596-1, an eighth row of values 536 is read out of memory bank 596-2, and multiplexer 588 selects a row representing the fourth row of the tile 114 to be transposed from the seventh row of values 534 and the eight row of values 536. Multiplexer 588 then provides the selected row of values as an output 580 to the floating point unit 356, and the matrix accelerator unit 146 uses this output 580 as input 572 for a fourth tile column write operation. During this fourth tile column write operation, the matrix accelerator unit 146 provides respective portions of the input 572 to input 508 of memory bank 596-2, input 516 of memory bank 596-4, input 524 of memory bank 596-6, and input 532 of memory bank 596-8 so that the matrix accelerator unit 146 writes values to a fourth column of the transposed tile 116 stored between memory banks 596-1, 596-3, 596-5, and 596-7. After writing the fourth column of the transposed tile 116, the matrix accelerator unit 146 updates, for example, tile metadata 122 to indicate that there is a valid transposed clone for the tile 114 to be transposed.

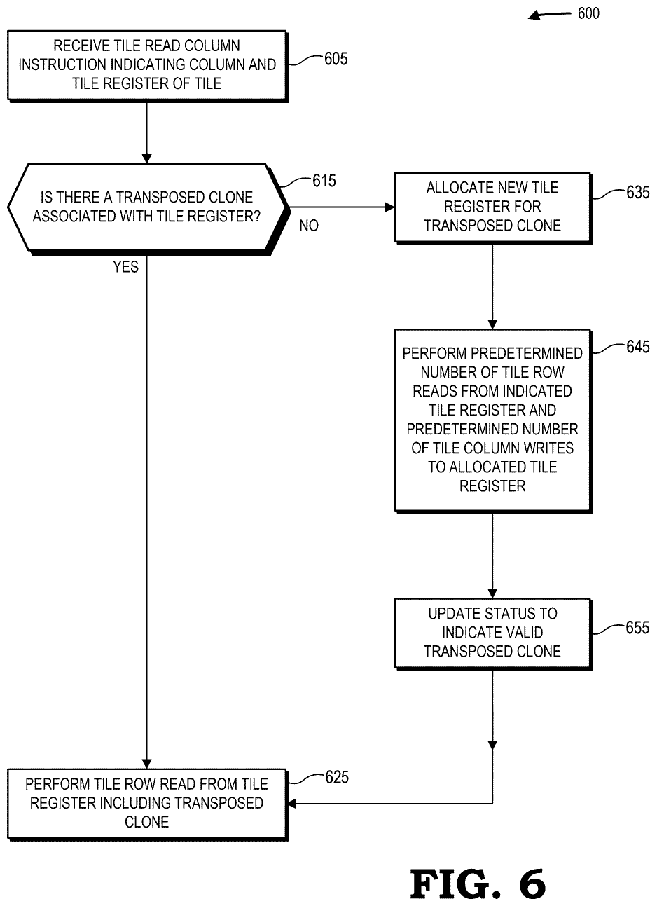

Referring now to FIG. 6, an example method 600 for executing a column read operation using a matrix accelerator unit is presented, in accordance with embodiments. Example method 600, for example, is performed by a matrix accelerator unit 146 while executing a tile read column instruction 140 supported by the matrix accelerator unit 146. Example method 600 includes, at block 605, the matrix accelerator unit 146 receiving, from processing unit 128, a tile read column instruction 140 indicating a column and tile register 112 (e.g., a tile register address) of a tile 114. When executing this tile read column instruction 140, at block 615, the matrix accelerator unit 146 determines whether there is a valid transposed clone for the tile 114 indicated by the tile read column instruction 140. That is to say, the matrix accelerator unit 146 determines whether there is a transposed tile 116 associated with the tile register 112 (e.g., tile register address) indicated by the tile write column instruction 140. To determine whether there is a transposed tile 116 associated with the tile 114 indicated by the tile read column instruction 140, the matrix accelerator unit 146, for example, checks the tile metadata 122 associated with the tile 114, tile register 112, or both indicated by the tile read column instruction 140 to determine whether a transposed tile 116 associated with the tile 114 is present. As another example, the matrix accelerator unit 146 checks one or more flags associated with the indicated tile 114, tile register 112, or both to determine whether a valid transposed clone of the tile 114 is present. As an additional example, the matrix accelerator unit 146 checks one or more encoded tile register addresses to determine whether a tile register 112 stores a transposed tile 116 associated with the indicated tile 114, tile register 112, or both.

In response to there being a transposed tile 116 associated with the indicated tile 114, tile register 112, or both stored in tile registers 112, at block 625, the matrix accelerator unit 146 performs a tile row read operation to read a row of values from the transposed tile 116 corresponding to the column of the tile 114 indicated by the tile read column instruction 140. Referring again to block 615, in response to there being no transposed tile 116 associated with the indicated tile 114, tile register 112, or both stored in tile registers 112, at block 635, the matrix accelerator unit 146 allocates a new tile register to store the transposed tile 116. As an example, the matrix accelerator unit 146 updates tile metadata 122 to indicate that a tile register 112 is allocated to store the transposed tile 116. After allocating the new tile register, at block 645, the matrix accelerator unit 146 performs a predetermined number of tile row read operations to read values from each row of the tile 114 indicated by the tile read column instruction 140. Further, the matrix accelerator unit 146 performs a predetermined number of tile column write operations to write the read out rows of values to the new tile register, such that the read out rows of values are written to corresponding columns of the transposed tile 116 stored in the new tile register. According to some embodiments, the matrix accelerator unit 146 is configured to interleave these tile row read operations and tile column write operations so that the read values are not written to vector registers 108. After completing the predetermined number of tile column write operations and producing the transposed tile 116, the matrix accelerator unit 146, at block 655, updates the tile metadata 122 to indicate there is a valid transposed clone (e.g., transposed tile 116) associated with the tile 114, tile register 122, or both indicated by the tile read column instruction 140. The matrix accelerator unit 146 then, at block 625, performs a tile row read operation to read a row of values from the transposed tile 116 corresponding to the column of the tile 114 indicated by the tile read column instruction 140.

In some embodiments, the apparatus and techniques described above are implemented in a system including one or more integrated circuit (IC) devices (also referred to as integrated circuit packages or microchips), such as the AU described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An accelerator unit (AU), comprising:
one or more compute units configured to perform matrix multiplication operations using a plurality of matrices; and
a matrix accelerator unit comprising tile registers configured to store the plurality of matrices, the matrix accelerator unit configured to read a column from a matrix of the plurality of matrices based on a transposed clone of the matrix stored in the tile registers.

2. The AU of claim 1, wherein the matrix accelerator unit is configured to:
receive an instruction to read the column from the matrix; and
in response to the transposed clone not being stored in the tile registers, generate the transposed clone.

3. The AU of claim 2, wherein the matrix accelerator unit is configured to generate the transposed clone by:
allocating a tile register of the tile registers to store the transposed clone;
performing tile row read operations on the matrix; and
performing tile column write operations to the tile register to produce the transposed clone.

4. The AU of claim 3, wherein the matrix accelerator unit is configured to interleave the tile row read operations and the column write operations.

5. The AU of claim 1, wherein the matrix accelerator unit is configured to provide portions of one or more matrices of the plurality of matrices as operands to the one or more compute units.

6. The AU of claim 1, wherein the matrix accelerator unit is configured to:
receive an instruction to read the column from the matrix; and
in response to the transposed clone being stored in the tile registers, reading a row of the transposed clone corresponding to the column of the tile.

7. The AU of claim 1, wherein the matrix accelerator unit is configured to:
maintain data indicating whether corresponding valid transposed clones for one or more matrices of the plurality of matrices are stored in the tile registers.

8. A method, comprising:
receiving, at a matrix accelerator unit, an instruction indicating a column of a tile stored in tile registers of the matrix accelerator unit is to be read; and
reading a row of a transposed clone stored in the tile registers corresponding to the column of the tile.

9. The method of claim 8, further comprising:
in response to the transposed clone not being stored in the tile registers, generating, by the matrix accelerator unit, the transposed clone.

10. The method of claim 9, wherein generating the transposed clone comprises:
allocating a tile register of the tile registers to store the transposed clone;
performing tile row read operations on the tile; and
performing tile column write operations to the tile register to produce the transposed clone.

11. The method of claim 10, wherein the tile row read operations and the column write operations are interleaved.

12. The method of claim 8, further comprising:
providing portions of one or more tiles stored in the tile registers as operands to one or more compute units of an accelerator unit including the matrix accelerator unit.

13. The method of claim 8, further comprising:
maintaining data indicating whether corresponding valid transposed clones for one or more tiles are stored in the tile registers.

14. A processing system, comprising:
a processing unit configured to issue an instruction indicating a column of a tile is to be read; and
an accelerator unit comprising tile registers configured to store the tile, the accelerator unit configured to:
read a column from the tile based on a transposed clone of the tile stored in the tile registers.

15. The processing system of claim 14, wherein the accelerator unit is configured to:
in response to the transposed clone not being stored in the tile registers, generate the transposed clone.

16. The processing system of claim 15, wherein the accelerator unit is configured to generate the transposed clone by:
allocating a tile register of the tile registers to store the transposed clone;
performing tile row read operations on the tile; and
performing tile column write operations to the tile register to produce the transposed clone.

17. The processing system of claim 16, wherein the accelerator unit is configured to interleave the tile row read operations and the column write operations.

18. The processing system of claim 14, wherein the accelerator unit is configured to provide portions of one or more tiles stored in the tile registers as operands to one or more compute units of the accelerator unit.

19. The processing system of claim 14, wherein the accelerator unit is configured to:
in response to the transposed clone being stored in the tile registers, reading a row of the transposed clone corresponding to the column of the tile.

20. The processing system of claim 14, wherein the accelerator unit is configured to:
maintain data indicating whether corresponding valid transposed clones for one or more tiles are stored in the tile registers.
